(19) United States
(12) Patent Application Publication
(10) Pub. No.: US 2008/0298079 A1
(43) Pub. Date: Dec. 4, 2008

(54) FIX-UR-FLAT LIGHT KIT

(76) Inventor: Rashad Cornell Whitehead, Raleigh, NC (US)

Correspondence Address: MICHAEL RIES, 318 PARKER PLACE, OSWEGO, IL, 60543, US

(21) Appl. No.: 11/633,103

(22) Filed: Jun. 2, 2007

(51) Int. Cl. B60Q 1/26

(52) U.S. Cl. 362/506

(57) ABSTRACT

This system is a device that provides lighting in all four wheel wells above the respective tire. Each of the lights is assembled into the wheel well where the housing is formed from the base. It is also covered with a fiber glass and plastic door to prevent any damage to the lighting device. The bulb for this system is very easy to install and will be sold at any automotive stores. The wiring of this system should be done by mechanic professionals to make sure of proper installation.

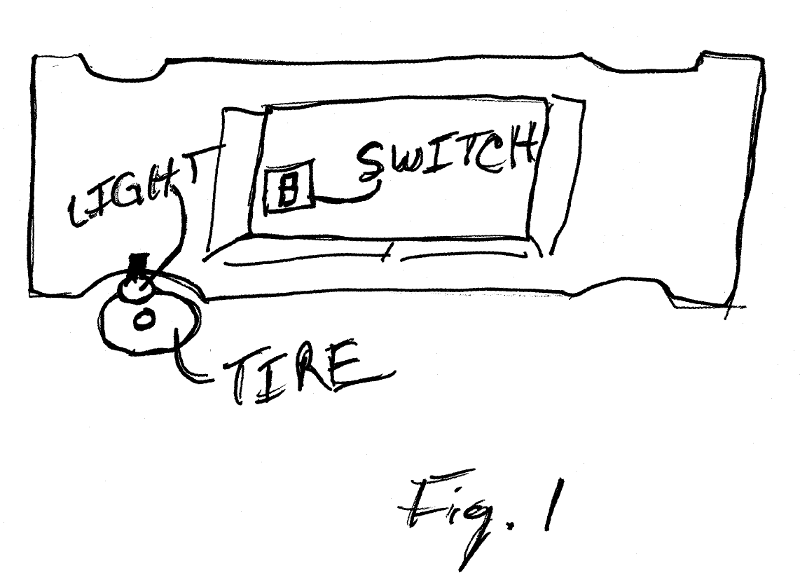

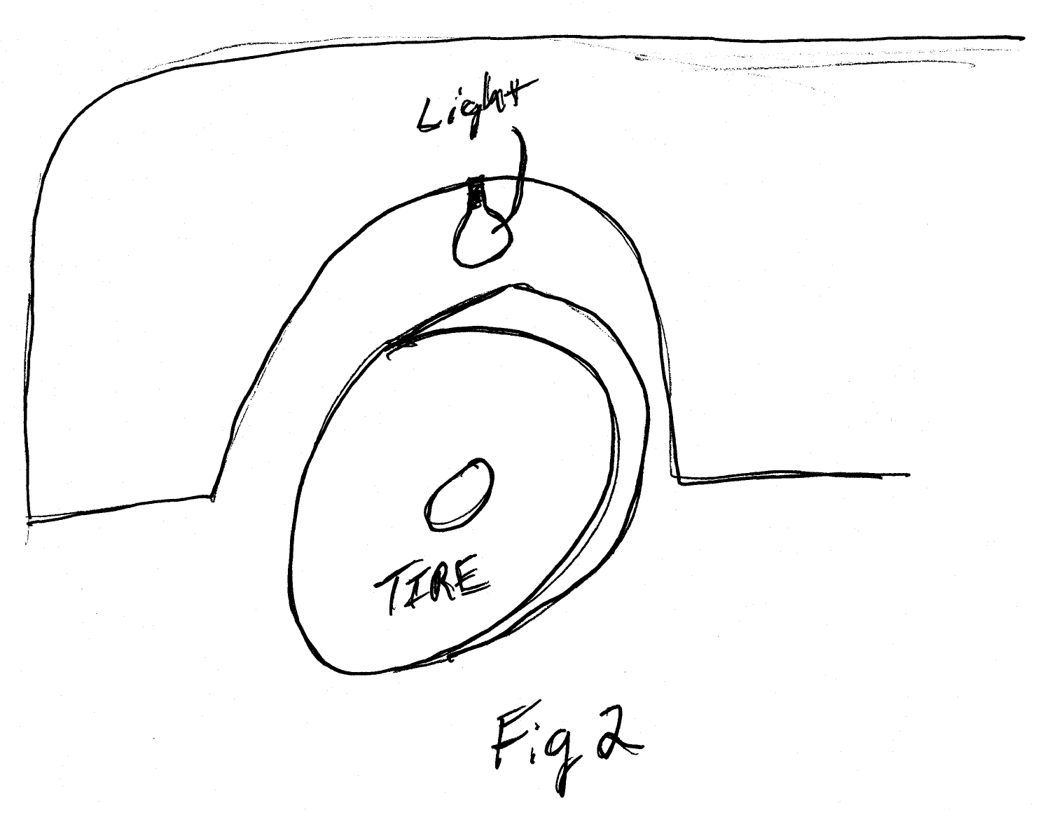

The concept of “FIX-UR-FLAT LIGHT KIT” is a set of wheel well lights for the vehicles to provide additional lighting when changing a flat tire along the roadside at night. This would illuminate the problem area so the vehicle owner operated the jack and lug wrench in a safe and controlled manner while being provided full visibility to the flat tire. It would help minimize roadside delays and enhance personal safety.

The product would be comprised primarily of four lights, control switches, insulated wiring, and mounting hardware. The rugged weatherproof lights would install within each of the wheel wells above the tires. They would each be equipped with a small slide-open access door for exposure when needed and protection while traveling.

The lights would be wired to the 12-volt DC electrical system of the vehicle for power. Each could be wired to a toggle switch, which is wired to the Hazard Light button in the interior for easy owner operation.

In the event of a flat tire on a dark roadside or parking lot at night, the motorist would activate the appropriate control switch. The individual could then proceed to change the flat with the wheel well are fully illuminated. This would help the motorist us the jack and lug wrench at night without groping for parts, risking a safety hazard, or fumbling with a flashlight. Once the tire was changed, the switch could be turned off to deactivate the lights for continued travel.

The “FIX-UR-FLAT LIGHT KIT” would be ideally suited for aftermarket automobiles and light trucks but could also be adapted for use with large trucks and other commercial vehicles. It could be offered to motorist as standard or optional equipment on new production vehicles.

### (This is my Claim # 1.)

### DESCRIPTION: PRODUCT CONCEPT REVIEW

I Rashad Cornell Whitehead have an idea called “FIX-UR-FLAT LIGHTS”.

“FIX-UR-FLAT LIGHTS”—is a set of wheel well lights for vehicles to provide additional lighting when changing a flat tire along the roadside at night. This would illuminate the problem area so the vehicle owner operated the jack and lug wrench in a safe and controlled manner while being provided full visibility to the flat tire. It would help minimize roadside delays and enhance personal safety.

The product would be compromised primarily of four lights, control switches, insulated wiring, and mounting hardware. The rugged weatherproof lights would be installed within each of the wheel wells above the tires. They would each be equipped with a small slide-open access door for exposure when needed and protection while traveling.

The lights would be wired to the 12-volt DC electrical system of the vehicle for power. Each could be wired to the emergency hazard switch located within the interior of the vehicle for easy owner access.

In the event of a flat tire on a dark roadside or parking lot at night, the motorist would activate the appropriate control switch. The individual could then proceed to change the flat tire with the wheel well fully illuminated. This would help motorist use the jack and lug wrench at night without groping for parts, risking a safety hazard, or fumbling with a flashlight. Once the tire is changed, the emergency hazard switch could be turned off to deactivate the lights for continued travel.

The “FIX-UR-FLAT LIGHTS” would be ideally suited for aftermarket automobiles and light trucks but adapted for use with large trucks and other commercial vehicles. Mainly I would prefer it to be offered to motorist as standard or optional equipment on new production vehicles.

### Function and Appealing Features

I have suggested “FIX-UR-FLAT LIGHTS” because I believe that this product would fulfill the need for hands-free lighting for changing a flat tire at night.

The appealing features of “FIX-UR-FLAT LIGHTS” would be their ease of use, safety, and convenience. Instead of fumbling in darkness with a car jack lug wrench while holding a portable flashlight, this specially designed lighting system integrated into the wheel well would illuminate the scene for changing the flat tire. It would reduce the time and effort spent performing the operation to minimize roadside delays.

By fully illuminating the problem area and performing a nighttime tire change, there would be no need to call a roadside assistance truck to the scene, thus preventing further delays and high service costs. It could provide peace of mind for safety-conscious motorist; the lighting system would be reliable, safe, and easily adapted to different vehicles.

### Variations

The potential exists for varying the production of “FIX-UR-FLAT LIGHTS” in ways, which could make them more appealing to a wider range of end users. This could include producing the system with multi-colored lighting. This could be used to customize, highlight, and accessorize vehicles for automotive enthusiasts by showing off the wheels in an interesting and eye-catching manner at shows and special events.

The access doors to expose the wheel well lights could be manually adjusted as required or motorized for added convenience. As previously mentioned, this system could be adapted for both aftermarket and new production vehicles.

I claim:

1. A wheel well light comprising:
at least one light attached to the wheel well of a vehicle; and
a switch to control the light.
